(19) United States
(12) Patent Application Publication
(10) Pub. No.: US 2018/0056981 A1
(43) Pub. Date: Mar. 1, 2018

(54) HYBRID VEHICLE AND METHOD OF EFFECTIVELY CONTROLLING ENGINE OFF

(71) Applicant: Hyundai Motor Company, Seoul (KR)

(72) Inventor: Jin Kuk Cho, Goyang (KR)

(21) Appl. No.: 15/384,778

(22) Filed: Dec. 20, 2016

(30) Foreign Application Priority Data
Sep. 1, 2016 (KR) 10-2016-0112430

(51) Int. Cl. B60W 20/40; B60K 6/48; B60W 10/06; B60W 10/08

(52) U.S. Cl. CPC B60W 20/40; B60K 6/48; B60W 10/06; B60W 10/08; Y10S 903/93; B60Y 2200/92; B60W 2710/083; B60Y 2300/182; B60W 2510/0676; B60W 2510/107; B60W 2520/00; B60W 2710/0644; B60W 2710/0666; B60Y 2300/192

(57) ABSTRACT

A hybrid vehicle and a method of controlling engine off are provided. The method includes turning off an engine in a desired state in a hybrid vehicle including a specific type powertrain. Particularly, the method includes entering an engine stop mode, stopping fuel injection and maintaining engine revolution per minute (rpm) in a first range using a first motor. Additionally, the method includes setting a second range of a crank angle of a stop angle control while the engine rpm is maintained in the first range and applying torque for engine off to the first motor when the crank angle is positioned in the set second range. The torque for engine off includes first torque for reducing the engine rpm and second torque for cancelling engine friction torque.

### CROSS REFERENCE TO RELATED APPLICATION(S)

This application claims the benefit of Korean Patent Application No. 10-2016-0112430, filed on Sep. 1, 2016, which is hereby incorporated by reference as if fully set forth herein.

### BACKGROUND

### Field of the Invention

The present invention relates to a hybrid vehicle and a method of controlling engine off, and more particularly, to a method of controlling engine off and a hybrid vehicle therefor, for turning off an engine in a desired state in a hybrid vehicle including a specific type powertrain.

### Discussion of the Related Art

In general, a hybrid electric vehicle (REV) refers to a vehicle that uses two power sources including an engine and an electric motor. An REV has improved fuel efficiency and engine performance compared with a vehicle including only an internal combustion engine and is also advantageous for reducing emissions and, thus, has been actively developed recently.

Such a hybrid vehicle may be driven in two modes according to a powertrain used to drive the vehicle. One of the modes is an electric vehicle (EV) mode in which the vehicle is driven using an electric motor and the other mode is a hybrid electric vehicle (HEV) mode for operating both an electric motor and an engine to acquire power. A hybrid vehicle performs conversion between the two modes based on driving conditions.

For example, when driving power of predetermined reference or greater is required, a vehicle may be driven in an HEV mode and, when driving power of less than a predetermined reference is required, the vehicle may be driven in an EV mode. However, when switching from the HEV mode to the EV mode, an engine is turned off, thus requiring the engine to be restarted. Particularly, vibration is generated when an engine is restarted and thus, vibration needs to be minimized to maintain operability and prevent displeasure of a driver.

Vibration during engine restart is affected by an angle at which a crankshaft stops when the engine is lastly turned off according to system characteristics. Accordingly, an amount of vibration is varied based on an angle at which the crankshaft stops when the engine is turned off. In particular, there is a need for a method of controlling engine off to minimize such vibration according to a structure of a powertrain of a hybrid vehicle. In particular, an engine is not allowed to be operated to repeatedly perform normal/reverse rotation at about a corresponding angle to gradually reduce a swing width of a crankshaft even when the crankshaft needs to be stopped at a desired angle in a powertrain configured to rotate an engine in one direction only.

### SUMMARY

Accordingly, the present invention provides a hybrid vehicle and a method of effectively controlling engine off that substantially obviates one or more problems due to limitations and disadvantages of the related art.

An object of the present invention is to provide a method of controlling engine off and a hybrid vehicle therefor, for minimizing vibration in a hybrid vehicle during engine restart. Another object of the present invention is to provide a method of controlling engine off, for stopping a crankshaft at a desired angle in a hybrid vehicle including a powertrain in which reverse rotation of an engine is not permitted.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of controlling engine off of a hybrid vehicle may include entering an engine stop mode, stopping fuel injection, maintaining engine revolution per minute (rpm) in a first range using a first motor, setting a second range of a crank angle of control of a stop angle when the engine rpm is maintained in the first range, and applying torque for engine off to the first motor when an angle of an engine crank is positioned in the set second range, wherein the torque for engine off may include first torque for reducing the engine rpm and second torque for cancelling engine friction torque.

In another aspect of the present invention, a power split-parallel hybrid vehicle may include an engine controller configured to operate an engine, a motor controller configured to operate a first motor and a second motor, and a hybrid controller configured to operate the engine controller and the motor controller. In particular, the hybrid controller may be configured to operate the engine controller to maintain engine revolution per minute (rpm) using the first motor when fuel injection is stopped in response to entering an engine stop mode, set a second range of a crank angle for control of a stop angle while the engine rpm is maintained in the first range, and operate the motor controller to apply torque for engine stop to the first motor when an angle of an engine crank is within the set second range, and the torque for engine stop may include first torque for reducing the engine rpm and second torque for cancelling engine friction torque.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIG. 1 is a diagram illustrating an example of a powertrain structure of a general parallel-type hybrid vehicle according to the related art;

FIG. 2A is a diagram illustrating an example of a powertrain of a power split-parallel hybrid vehicle according to an exemplary embodiment of the present invention;

FIG. 2B is a diagram illustrating lever lines of an example of a torque relationship between motors and an engine when the engine is operated according to an exemplary embodiment of the present invention;

FIG. 3 is a graph illustrating an example of when a general parallel-type hybrid vehicle performs kill torque control according to an exemplary embodiment of the present invention;

FIGS. 4A and 4B are diagrams illustrating an example of an engine off control is performed in a general power split hybrid vehicle that allows a general engine to rotate in a reverse direction according to an exemplary embodiment of the present invention;

FIGS. 5A and 5B are diagrams illustrating vibration tendency according to a crankshaft angle during engine restart according to an exemplary embodiment of the present invention;

FIG. 6 is a flowchart illustrating an example of a procedure of controlling engine off according to an exemplary embodiment of the present invention;

FIG. 7 is a diagram illustrating an engine off control procedure using rpm and torque according to an exemplary embodiment of the present invention; and

FIG. 8 is a flowchart illustrating an example of a system shutdown procedure according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Reference will now be made in detail to a hybrid vehicle and an effective shift control method therefor according to exemplary embodiments of the present invention, examples of which are illustrated in the accompanying drawings. The suffixes “module” and “unit” of elements herein are used for convenience of description and thus can be used interchangeably and do not have any distinguishable meanings or functions.

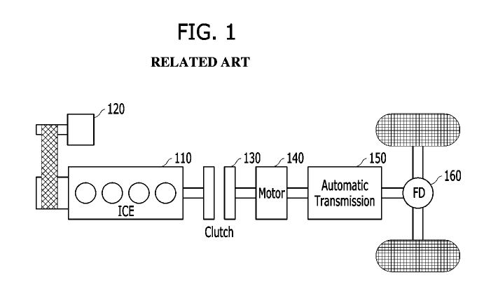

Prior to description of a method of controlling engine stop according to exemplary embodiments of the present invention, a powertrain structure of a hybrid vehicle, an engine-off process for each structure, and vibration during engine restart will be described with reference to FIGS. 1 to 5.

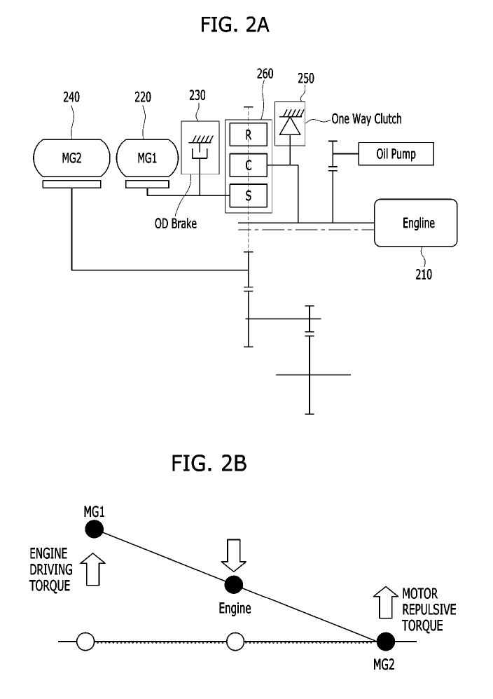

First, with reference to FIGS. 1 and 2A-2B, a powertrain structure of a hybrid vehicle will be described below. FIG. 1 is a diagram illustrating an example of a powertrain structure of a general parallel-type hybrid vehicle according to the related art. FIG. 1 illustrates a powertrain of a hybrid vehicle including a parallel type hybrid system including an electric motor 140 (or a driving motor) and an engine clutch 130 installed between an internal combustion engine (ICE) 110 and a transmission 15.

In such a vehicle, in general, when a driver engages an accelerator (e.g., exerts pressure onto an acceleration pedal) after turning on the vehicle, the motor 140 is driven using power of a battery while the engine clutch 130 is opened and transmits power to move wheels through the transmission 150 and a final drive (FD) 160 (i.e., EV mode). As the vehicle gradually accelerates, driving force is further required and thus, an auxiliary motor (or a start generator motor 120) may be operated to drive the engine 110.

Accordingly, when rotational speeds of the engine 110 and the motor 140 are about the same, the engine clutch 130 may then be engaged to use both the engine 110 and the motor 140 to drive the vehicle (i.e., transition into an HEY mode from an EV mode). When a preset engine off condition such as vehicle deceleration is satisfied, the engine clutch 130 is opened and the engine 110 may be stopped (i.e., transition into an EV mode from an HEV mode). In particular, the vehicle may be configured to recharge a battery using a motor using driving force of a wheel, referred to as braking energy regeneration or regenerative braking. Accordingly, the start generator motor 120 may operate as a starter motor when the engine is turned on and as a generator after the engine is turned on or when rotational energy is recovered during engine off and, thus, the start generator motor 120 may also be referred to as a hybrid start generator (HSG).

Hereinafter, with reference to FIG. 2A, powertrains of a power split hybrid vehicle and a power split-parallel hybrid vehicle will be described. FIG. 2A is a diagram illustrating an example of a powertrain of a power split-parallel hybrid vehicle according to an exemplary embodiment of the present invention.

Referring to FIG. 2A, comparing the powertrain of the power split-parallel hybrid vehicle with that of the aforementioned parallel type hybrid vehicle described with reference to FIG. 1, the hybrid vehicles are similar to each other in that two different motors 220 and 240 use one engine 210 but the powertrain of the power split-parallel hybrid vehicle of FIG. 2A does not include the engine clutch 130. In addition, a first motor 220 that corresponds to an HSG of the parallel type powertrain, a second motor 240 as a main motor, and an engine 210 may be connected to each other via a planetary gear 260. In particular, the first motor 220 may be configured to rotate a sun gear S, the second motor 240 may be configured to rotate an external gear, and the engine 210 may be configured to rotate a ring carrier C including a plurality of ring gears R.

The parallel type hybrid vehicle is similar to a power split hybrid vehicle in terms of the features described thus far, but the power split-parallel type powertrain may further include an overdrive (OD) brake 230 and a one-way clutch (OWC) 250. When an operation of the first motor 220 is not required such as when required power at high speed is low, the OD brake 230 may prevent the first motor 220 from rotating to implement an overdrive mode in which the second motor 240 and the engine 210 are driven together. Accordingly, in the power split-parallel type powertrain, an OD mode as well as an EV mode and a power split mode may be supported.

Further, the OWC 250 may prevent an engine from rotating in a reverse direction by allowing the engine to rotate in a direction determined during design without limitations and limiting the engine not to rotate in the reverse direction. When reverse rotation is caused by strong force, the OWC 250 may be damaged. Accordingly, in the power split-parallel type powertrain, both the first motor 220 and the second motor 240 may be driven together in an EV mode. Additionally, the power split powertrain may not include an OWC or OD brake and thus, is configured to allow an engine to rotate in opposite directions.

FIG. 2B is a diagram illustrating lever lines of an example of a torque relationship between motors and an engine when the engine is operated. Referring to FIG. 2B, when an engine is turned off (i.e., prior to fuel injection), only friction torque is present and, thus, an arrow is directed downward, and a first motor generates torque upward to increase rotational speed of the engine. In particular, torque applied to the first motor based on the leverage principle influences the second motor using the engine as a central axis. The torque that influences the second motor may function as torque that impedes rotation of the second motor in a normal direction. This may impede operability and, thus, repulsive torque may be applied to the second motor to cancel the torque that influences the second motor. Accordingly, motor repulsive torque for the second motor is indicated in an upper direction.

Although the powertrain structures are different, the powertrains are similar control systems as follows. In a hybrid vehicle, an internal combustion engine may be operated by an engine management system (EMS) and the start generator motor (first motor) and the main motor (second motor) may be operated based on torque by a motor control unit (MCU). In addition, the transmission 150 may be operated by a transmission controller.

Each controller may be connected to a mode conversion controller (or a hybrid controller (HCU) which may be considered an upper controller) configured to execute an overall mode conversion procedure and may provide information required to change a driving mode and to operate an engine clutch during gear transmission, and/or information required to turn the engine off or may perform an operation according to a received control signal. Particularly, the mode conversion controller may be configured to determine whether a mode is converted based on a driving state of a vehicle. For example, the mode conversion controller may be configured to adjust a stop time of fuel injection of the engine to turn the engine off or may be configured to transmit a torque command for adjusting torque of the first and second motors to the motor controller.

It would be obvious to one of ordinary skill in the art that the aforementioned relationship between controllers and functions/divisions of the controllers are exemplary and, thus, are not limited to the terms. For example, the mode conversion controller may be embodied by allowing any one of other controllers except for the mode conversion controller to provide a corresponding function or two or more of other controllers may distribute and provide the corresponding function.

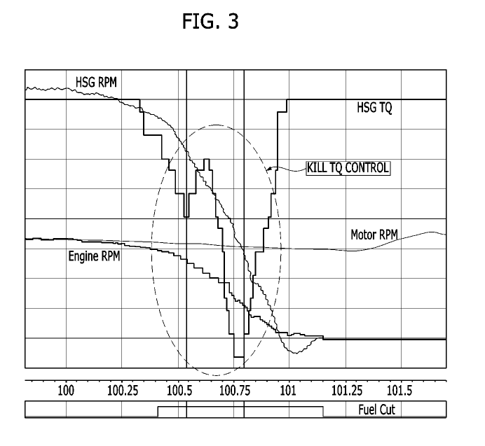

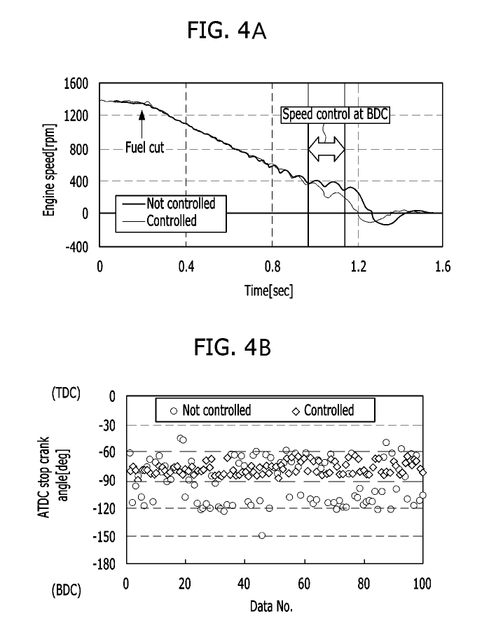

Based on the aforementioned powertrain structure, a general engine stop control method will be described with reference to FIGS. 3 and 4A-4B. A hybrid vehicle may be configured to rapidly reduce engine rotational speed by an electric motor during engine off, which may be referred to as kill torque control. Accordingly, driver displeasure due to vibration generated at specific rotational speed (revolution per minute (rpm)) may be prevented when the engine stops according to engine inertia.

FIG. 3 is a graph illustrating an example when a general parallel-type hybrid vehicle performs kill torque control. In particular, torque to be output by a start generator motor (HSG) may be determined based on engine rotational speed (rpm) and, in this regard, the output torque may be configured with map data via experimentation during vehicle development. Referring to FIG. 3, engine rpm may be decreased to a specific engine rpm via kill torque (HSG TQ) control of a start generator motor, and when the engine rpm reaches a range of a specific rpm or less, kill torque may be removed and the engine stops according to engine inertia.

Hereinafter, a power split hybrid vehicle will be described with reference to FIGS. 4A-4B. Particularly, FIGS. 4A and 4B are diagrams illustrating an example of when engine off control is performed in a general power split hybrid vehicle that allows a general engine to rotate in a reverse direction. In FIGS. 4A and 4B, it may be assumed that an engine of a power split hybrid vehicle has minimized vibration in a range of about 60 to 90 degrees before top dead center (BTDC) as a crank angle at which the engine stops.

FIG. 4A is a graph illustrating a procedure of adjusting engine speed. Referring to FIG. 4A, fuel injection stops (e.g., fuel cut) to turn the engine off and rotational speed of the engine may be maintained at rotational speed of about 150 to 220 rpm via kill torque control using the first motor. When torque of the first motor is adjusted to be 0 at a time point at which a crank angle of the engine reaches a bottom dead center (BDC) during kill torque control, the engine may repeatedly rotate in normal/reverse directions and then may stop as rotational speed of the engine is reduced due to frictional force and inertia of the engine. The crank angle during engine stop via kill torque control may be about 60 to 90 degrees before top dead center (BTDC).

An effect of adjusting an engine off angle is shown in FIG. 4B. Particularly, FIG. 4B illustrates that when the engine off angle is not adjusted, a crank angle during engine stop may be distributed without a predetermined pattern, and when an engine off angle is adjusted, the crank angle during engine stop may converge between about 60 to 90 degrees before top dead center (BTDC).

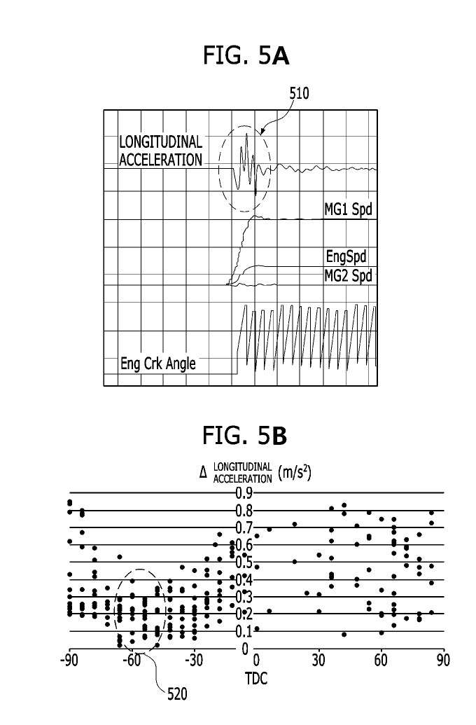

Hereinafter, the reason for control of an engine off angle will be described in more detail with reference to FIGS. 5A and 5B. FIGS. 5A and 5B are diagrams illustrating vibration tendency according to a crankshaft angle during engine restart.

As seen from FIG. 5A, in a power split-parallel powertrain, a longitudinal acceleration 510 (i.e., vibration) is generated during engine start. The vibration may be formed by amplifying rpm of the engine through a resonance region of a corresponding system during engine start and, in this regard, vibration may be transmitted to a vehicle through a driving axis and transmitted to a driver, adversely affecting operability.

Accordingly, vibration should be minimized during engine start and, thus, it may be necessary to adjust an engine off angle for minimizing vibration.

As seen from FIG. 5B, amplitude of generated longitudinal acceleration, i.e., vibration tendency may be varied according to an engine (crank) off angle. In particular, a crank off angle is observed to be relatively low at an angle 520 adjacent to −60 degrees of top dead center (TDC). A detailed crank angle at which relatively low vibration is generated may be varied according to structural characteristics of the engine.

For adjustment of an engine off angle, a hybrid vehicle using a power split-parallel powertrain may consider the aforementioned control of an engine angle of an engine with reference to FIGS. 4A and 4B, but a problem arises in that a one-way clutch (OWC) is installed in the power split-parallel powertrain. In other words, there is a need for device to adjust an engine off angle when the engine rotation of a reverse direction is not allowed due to an OWC and the OWC damage due to kill torque may be prevented.

Accordingly, according to an exemplary embodiment of the present invention, when a hybrid vehicle using a power split-parallel powertrain adjusts an engine off angle, torque blending may be performed using the second motor and, then, the engine may rotate in a specific RPM band in which the engine is operated using the first motor. Accordingly, kill torque may be applied in the corresponding RPM band, the engine may stop at a desired crank angle as the engine is prevented from rotating in a reverse direction according to torque for cancelling friction torque of the engine to protect the OWC.

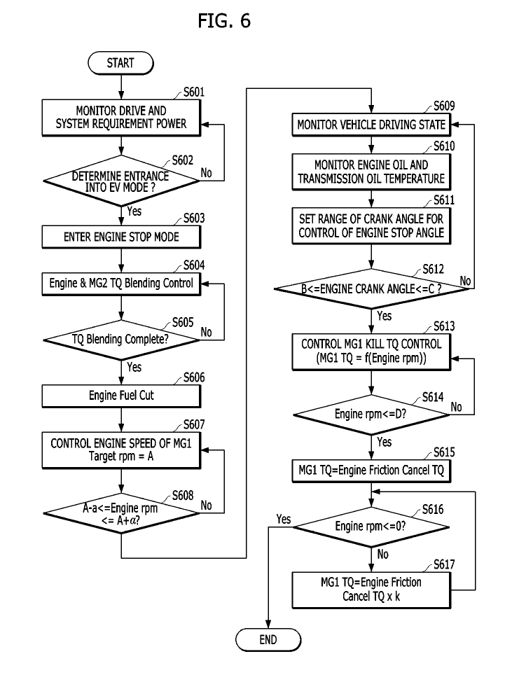

The aforementioned control procedure of engine off will be described in detail with reference to FIG. 6. FIG. 6 is a flowchart illustrating an example of a procedure of controlling engine off (e.g., turning the engine off) according to an exemplary embodiment of the present invention. Referring to FIG. 6, a hybrid controller may be configured to determine whether a current mode enters an EV mode (S602) while monitoring drive and system requirement power (S601).

In response to determining that the current mode enters the EV mode, the hybrid controller may be configured to enter an engine off control mode (S603) and torque blending may be performed using a second motor (S604). Particularly, torque blending may refer to compensating for output that corresponds to a reduced amount of output of the engine by the second motor to reduce the output torque of the engine to idle torque while driver requirement torque is satisfied.

When torque blending is completed, that is, when torque of the engine reaches an idle torque (S605), fuel injection of the engine may be stopped by the engine controller (S606). The hybrid controller may be configured to rotate the engine in a band at specific rpm via the first motor to stop the engine at a desired crank angle (S607 and S608). In the flowchart, ‘A’ may refer to target engine rotational speed for adjusting an engine off angle and ‘a’ may refer to margin to be allowed for A.

When engine rpm is excessively high, change in an engine crank angle varying per 10 ms (e.g. a period for transmitting and receiving a controller area network (CAN) communication signal) transmitted from an engine controller is excessively high and, thus, it may be difficult to detect a desired angle. When engine rpm is excessively low, change in frictional force due to rotation of an engine cylinder may adversely affect operability. Accordingly, when engine rpm is maintained to satisfy such a condition, inertial energy for reducing engine rpm may be removed to more accurately adjust engine rotation using only the first motor. A specific rpm band may be varied according to engine characteristics and, thus, may be determined according to design specification or determined via experimentation.

Additionally, a hybrid controller may be configured to monitor a driving state of a vehicle during rotation in a specific rpm band (S609), monitor various oil temperatures (S610), and set a range of a crank angle for adjusting an engine off angle according to the result (S611). In the flowchart, B and C indicate a lower limit and a higher limit, respectively, for each range of an engine crank angle for adjusting an engine off angle.

In particular, a range of the crank angle may be a factor varying according to system characteristics and may be determined through experimentation. The range is a factor affected by a driving state of a vehicle, system characteristics, and so on and, thus, needs to be monitored. In other words, frictional characteristics of a system are changed according to a transmission oil temperature, an engine oil temperature, and so on, and even when an engine off angle is adjusted at the same time during coasting driving and braking situation of a vehicle, final stop crank angles may be different.

When a crank angle of an engine enters a specific range, the hybrid controller may be configured to apply feed forward torque to the first motor to adjust an engine stop angle. Particularly, the feed forward torque may be composed of kill torque for reducing engine rpm and torque for cancelling friction torque to prevent the OWC from being damaged. The feed forward torque may be applied since the adjustment may vary for each situation in feedback control to change a crank angle at which the engine stops and, thus, the feed forward torque (i.e., the same torque at the same time) may be applied to minimize factors for changing system behavior.

In particular, kill torque by the first motor may be applied (S613). In addition, amplitude of kill torque may be determined using engine rpm as a variable. When engine rpm according to kill torque is decreased to preset rpm (D) or less (S614), the kill torque may be removed and torque for cancelling friction torque of the engine may be applied to the first motor. (S615). When engine rpm does not converge on 0 at a time point at which torque for cancelling friction torque is applied (S616), the torque applied to the first motor may be gradually reduced to cause the engine rotational speed to converge on 0 (S617). A reduction factor k may be a reduction factor of the first motor for allowing the engine rotational speed to converge on 0 and may have a value between 0 and 1.

In the aforementioned procedure of applying the feed forward torque, the torque may be applied to the first motor by transmitting a torque command to a motor controller by the hybrid controller. During the aforementioned engine off control procedure described with reference to FIG. 6, the engine, the first motor, and the second motor may further perform the repulsive torque control described with reference to FIG. 2B as well as control such as torque blending and engine off angle adjustment.

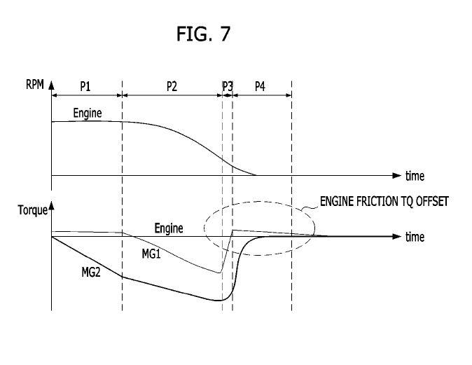

FIG. 7 is a diagram illustrating an engine off control procedure using rpm and torque according to an exemplary embodiment of the present invention. In FIG. 7, it may be assumed that engine off control is performed when a vehicle stops. First, a period P1 is a period for monitoring a crank angle of an engine, in which engine rpm may be adjusted by the first motor and the period P1 is transitioned to a period P2 when entering into a specific crank angle range (which corresponds to operations S607 to S612 of FIG. 6).

In the period P2, kill torque control for reducing engine rotational speed may be performed (S615˜S614) and, in a period P3, kill torque control may be removed and torque may be changed at a predetermined inclination up to a torque value for cancelling friction torque (S614 to S615). In a period P4, friction torque of the engine may be cancelled and torque reduction control for prevention of reverse rotation of the engine may be performed (S616 to S617).

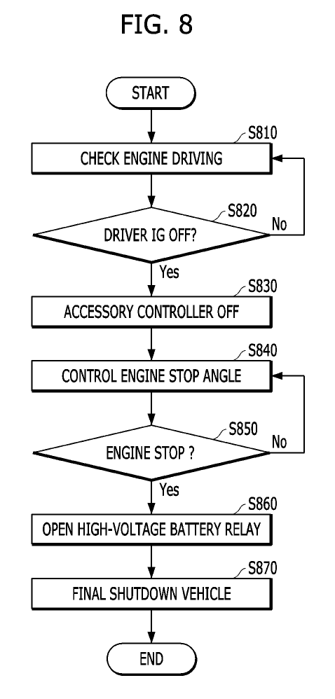

The aforementioned control of an engine off angle may be performed during engine off control in an HEV ready state (e.g., when a hybrid vehicle is capable of being driven) but may not be capable of being performed due to power of a high-voltage battery being disconnected during engine off (IG Off) based on a driver need when the engine is driven. Further, when the driver turns on the vehicle to drive the engine, vibration may be generated and may operate as a factor degrading productivity of the vehicle. Accordingly, a high-voltage relay of the battery may be disconnected and a condition “engine rpm=0” for shutting down a system may be added to an existing condition, which will be described with reference to FIG. 8.

FIG. 8 is a flowchart illustrating an example of a system shutdown procedure according to an exemplary embodiment of the present invention. Referring to FIG. 8, whether an engine is driven may be detected (S810). When a driver changes a key box state to an IG Off state during driving of the engine (e.g., start button push, key box rotation, etc. S820), accessory (ACC) controllers except for the powertrain element controllers (EMS, HCU, MCU, TCU, BMS, LDC, HDC, EEWP, etc.) may be turned off first (S830). While the ACC controllers are turned off, the engine off angle adjustment described with reference to FIGS. 6 and 7 may be performed (S840), and when engine off is confirmed, a high-voltage battery relay may be opened (S860) and the vehicle may finally be shutdown (S870).

According to the aforementioned exemplary embodiments of the present invention, engine rpm may be decreased to a comparatively low rpm via kill torque of the first motor and, thus, rapid mode conversion may be expected. In particular, in a general power split-parallel powertrain according to the related art, kill torque is removed at relatively high rpm to prevent reverse rotation of the engine but, according to the exemplary embodiment of the present invention, engine inertia may be cancelled at an engine off time and, thus kill torque may be reduced to a comparatively low rpm.

Torque for cancelling friction torque of the engine may be applied and, thus, engine inertia of the engine may be reduced to reduce shock applied to an OWC, thereby enhancing system durability. In addition, according to general control of a stop angle, reverse rotation of an engine is not thoroughly prevented and, thus, when the engine has inertia for reverse rotation, an OWC may be damaged due to strong shock. Thus, according to the exemplary embodiments of the present invention, shock applied to the OWC may be reduced by reducing engine inertia and may also prevent displeasure of a driver due to the corresponding shock.

The aforementioned present invention may also be embodied as computer readable code stored on a non-transitory computer readable recording medium. The non-transitory computer readable recording medium is any data storage device that may store data which can thereafter be read by a computer. Examples of the computer readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, carrier wave (e.g., transmission via the Internet), etc.

The hybrid vehicle configured as described above according to at least one exemplary embodiment of the present invention may minimize vibration during engine restart. In particular, torque control may be performed to prevent reverse rotation of the engine at different time points in two different motors and, thus, a device for prevention of reverse rotation may be protected and the engine may also stop at a desired crankshaft angle.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

What is claimed is:

1. A method of controlling engine off of a hybrid vehicle, comprising:
entering, by a controller, an engine stop mode;
maintaining, by the controller, an engine revolution per minute (rpm) in a first range using a first motor;
setting, by the controller, a second range of a crank angle for a stop angle control while the engine rpm is maintained in the first range; and
applying, by the controller, torque for turning off an engine to the first motor when the crank angle is positioned in the set second range,
wherein the torque for turning off the engine includes first torque for reducing the engine rpm and second torque for cancelling engine friction torque.

2. The method according to claim 1, wherein the applying of the torque includes:
applying, by the controller, the first torque to the first motor; and
removing, by the controller, the first torque when the engine rpm is within a third range.

3. The method according to claim 2, wherein the applying of the torque further includes applying the second torque to the first motor after the first torque is removed.

4. The method according to claim 3, wherein torque applied to the first motor is changed with a predetermined inclination until the second torque is applied after the first torque is removed.

5. The method according to claim 3, further comprising gradually reducing the second torque when the engine rpm does not converge on 0 after the second torque is applied.

6. The method according to claim 1, further comprising performing torque blending using a second motor prior to stopping of fuel injection.

7. The method according to claim 6, wherein the performing of the torque blending includes:
reducing, by the controller, torque of the engine; and
compensating, by the controller, the reduced torque of the engine by torque of the second motor to satisfy system requirement torque.

8. The method according to claim 1, wherein the setting of the second range includes:
monitoring, by the controller, at least one of a vehicle driving state, an engine oil temperature, and a transmission oil temperature; and
determining, by the controller, the second range based on a result of the monitoring.

9. The method according to claim 1, wherein the hybrid vehicle includes a clutch for prevention of reverse rotation of the engine.

10. A hybrid vehicle, comprising:
an engine controller configured to operate an engine;
a motor controller configured to operate a first motor and a second motor; and
a hybrid controller configured to operate the engine controller and the motor controller,
wherein: the hybrid controller is configured to:
operate the engine controller to maintain engine revolution per minute (rpm) using the first motor based on entering into an engine stop mode;
set a second range of a crank angle for a stop angle control while the engine rpm is maintained in the first range; and
operate the motor controller to apply torque for engine stop to the first motor when the crank angle is within the set second range, and
wherein the torque for engine stop includes first torque for reducing the engine rpm and second torque for cancelling engine friction torque.

11. The hybrid vehicle according to claim 10, wherein the hybrid controller is configured to operate the motor controller to remove the first torque when the engine rpm is within a third range after applying of the first torque to the first motor.

12. The hybrid vehicle according to claim 11, wherein the hybrid controller is configured to operate the motor controller to apply the second torque to the first motor after the first torque is removed.

13. The hybrid vehicle according to claim 12, wherein torque applied to the first motor is changed with a predetermined inclination until the second torque is applied after the first torque is removed.

14. The hybrid vehicle according to claim 12, wherein the hybrid controller is configured to operate the motor controller to gradually reduce the second torque when the engine rpm does not converge on 0 after the second torque is applied.

15. The hybrid vehicle according to claim 10, wherein the hybrid controller is configured to execute torque blending using a second motor before fuel injection is stopped.

16. The hybrid vehicle according to claim 15, wherein the hybrid controller is configured to operate the engine controller to reduce torque of the engine and to compensate the reduced torque of the engine by torque of the second motor to satisfy system requirement torque.

17. The hybrid vehicle according to claim 10, wherein the hybrid controller is configured to monitor at least one of a vehicle driving state, an engine oil temperature, and a transmission oil temperature and determine the second range according to a result of the monitoring.

18. The hybrid vehicle according to claim 10, further comprising a clutch for prevention of reverse rotation of the engine.

19. The hybrid vehicle according to claim 10, further comprising:
a battery configured to supply power to the first motor and the second motor; and
a relay configured to control electric connection of the battery,
wherein entering into an engine stop mode includes ignition off while the engine is driven and when the ignition is off, the relay is opened after the engine stops.

20. The hybrid vehicle according to claim 19, wherein when the ignition is off while the engine is driven, the engine controller and the motor controller are configured to operate the engine and the first motor until the engine stops.
